(19) United States
(12) Patent Application Publication
(10) Pub. No.: US 2013/0295950 A1
(43) Pub. Date: Nov. 7, 2013

(54) Method and Apparatus for Reporting Channel Information

(71) Applicants: Paivi Ruuska, Tampere (FI); Antti Piipponen, Vantaa (FI); Lei Du, Beijing (CN)

(72) Inventors: Paivi Ruuska, Tampere (FI); Antti Piipponen, Vantaa (FI); Lei Du, Beijing (CN)

(73) Assignee: Nokia Siemens Networks Oy, Espoo (FI)

(21) Appl. No.: 13/980,323

(22) PCT Filed: Jan. 18, 2011
(86) PCT No.: PCT/CN2011/070357

§ 371 Date: Jul. 18, 2013

(51) Int. Cl. H04W 72/10

(52) U.S. Cl. CPC H04W 72/10
USPC 455/452.1

(57) ABSTRACT

In accordance with an example embodiment of the present invention, apparatus including a transmitter configured to output information, a processing core configured to obtain information concerning in-device multiradio interference, the processing core being configured to assign at least one priority to at least one channel of a first radio access technology in dependence of the information concerning in-device multiradio interference, and the processing core being configured to cause the transmitter to output channel information including an indication of the at least one priority for transmission to a base station of the first radio access technology.

### TECHNICAL FIELD

The present application relates generally to multiradio coexistence and channel use coordination.

### BACKGROUND

In recent years, mobile telecommunication have increased and people have become increasingly connected via wireless communication devices, such as terminals. Terminals can communicate using a variety of radio access technologies, such as cellular technologies and local area network technologies. Examples of cellular technologies include global system for mobile communications, GSM, wideband code division multiple access, WCDMA, and long term evolution, LTE, technologies. Examples of local area network technologies include wireless local area network, WLAN, or Zigbee, technologies. Examples of short-range technologies include Bluetooth, or ANT+ technologies.

Different technologies have different advantages, for example cellular technologies may provide wide-area or even global coverage, whereas local-area technologies may provide inexpensive and fast data transfer. It is therefore in some cases preferable to furnish a single wireless communication device with capability to communicate using more than one technology. Some technologies, such as satellite positioning using, for example, global system for positioning, GPS, or the Galileo constellation, require a mobile device to only be capable of receiving signals according to the technology while others also involve transmission of signals.

Different communication technologies usually use different parts of the spectrum, but on occasion spectra used by different technologies may overlap. The technologies may operate on the same band, or in adjacent channels, and cause interference to each another in the device. In addition to direct spectrum overlap, a first communication technology may produce in a device internal harmonics of frequencies in use, which may produce spurious energy peaks on frequency bands used by a second communication technology in the same device.

### SUMMARY

Various aspects of examples of the invention are set out in the claims.

According to a first aspect of the present invention, there is provided an apparatus comprising a transmitter configured to output information, a processing core configured to obtain information concerning in-device multiradio interference, the processing core being configured to assign at least one priority to at least one channel of a first radio access technology in dependence of the information concerning in-device multiradio interference, and the processing core being configured to cause the transmitter to output channel information comprising an indication of the at least one priority for transmission to a base station of the first radio access technology

According to a second aspect of the present invention, there is provided a method comprising obtaining information concerning in-device multiradio interference, assigning at least one priority to at least one channel of a first radio access technology in dependence of the information concerning in-device multiradio interference, and causing a transmitter to output channel information comprising an indication of the at least one priority for transmission to a base station of the first radio access technology;

According to a third aspect of the present invention, there is provided an apparatus comprising at least one processor, at least one memory including computer program code, the at least one memory and the computer program code configured to, with the at least one processor, cause the apparatus to perform at least receiving channel information comprising an indication of at least one priority assigned to at least one channel of a first radio access technology, choosing a channel of the first radio access technology for communication with a mobile station in dependence of the channel information and information relating to a communication to be established over the channel, wherein the channel information comprises information on at least one blocked channel, and an indication of priority relating to the at least one blocked channel.

According to a fourth aspect of the present invention, there are provided computer programs, in some embodiments embodied on non-transitory computer-readable media, configured to cause methods according to the second aspect to be performed when run on at least one computer.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system capable of supporting embodiments of the invention.

FIG. 2 illustrates an example apparatus 201 capable of supporting embodiments of the present invention.

FIG. 3 is a signaling diagram relating to an example embodiment of the invention; and

FIG. 4 illustrates information on potential interference according to an example embodiment of the invention.

FIG. 5 is a flowchart of a method according to an example embodiment of the invention.

### DETAILED DESCRIPTION OF THE DRAWINGS

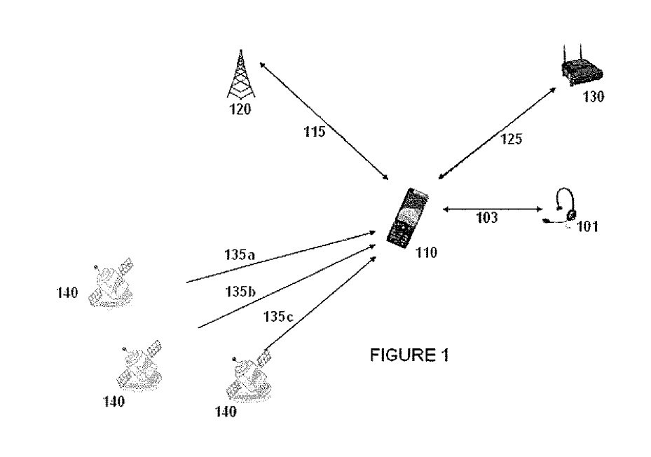

An example embodiment of the present invention and its potential advantages are understood by referring to FIGS. 1 through 5 of the drawings.

FIG. 1 illustrates an example system capable of supporting embodiments of the invention. Illustrated is apparatus 110, or mobile 110, which may be a mobile terminal, such as a mobile phone, for example. Mobile 110 is configured to communicate with a cellular system via base station 120. Base station 120 may conform to one or more cellular technologies, such as for example WCDMA or LTE technologies. Communication between mobile 110 and base station 120 may occur by means of wireless link 115, which is in conformance with a first radio access technology, such as a cellular technology. Link 115 may comprise an uplink for conveying information from mobile 110 to base station 120, and a downlink for conveying information from base station 120 to mobile 110. Base station 120 may be configured to manage link 115 in accordance with the first radio access technology, for example base station 120 may allocate radio resources such as, for example, radio channels and/or time slots to link 115. The cellular network in which base station 120 is comprised may comprise further nodes, which are not illustrated in FIG. 1. The further nodes may include gateways, mobility management entities, subscriber databases and policy control functions, for example. Mobile 110 may obtain services of a cellular network via link 115 and base station 120. Cellular network services may include voice calls, multimedia messaging and internet access, for example.

Mobile 110 may be furnished with capability to communicate with access point 130, which operates according to a local area network technology such as WLAN or Zigbee. Link 125 is arranged between mobile 110 and access point 130, and interconnects mobile 110 and access point 130 to allow bidirectional communication thereinbetween. Mobile 110 may be configured to be capable of simultaneously communicating with base station 120 and access point 130 using links 115 and 125, respectively. Mobile 110 may obtain local area network services, such as internet or email access, via link 125 and access point 130.

Illustrated in FIG. 1 are also positioning satellites 140. Mobile 110 may be capable of receiving signals from positioning satellites 140 via wireless satellite links 135a, 135b and 135c. Additionally or alternatively, also bidirectional satellite communication via telecommunication satellites such as the Iridium network may be possible, for example. The number of satellites which mobile 110 is capable of receiving signals from, or transmitting signals to, simultaneously, is not necessarily three although three satellites are illustrated in FIG. 1. Satellite connectivity may thu provide mobile 110 with positioning and/or satellite voice/data connectivity, depending on the embodiment.

Illustrated in FIG. 1 is also a wireless headset 101, with which mobile 110 may be configured to communicate using wireless link 103. Wireless link 103 may be a short-range wireless link, such as a bidirectional short-range wireless link. Short-range link 103 may operate in accordance with the Bluetooth or ANT+ technology, for example. Using wireless headset 101, a user of mobile 110 may obtain hands-free voice communication via cellular, satellite or local-area connectivity. Short-range technologies may be used also for other purposes, such as device-to-device file sharing, receiving sensor values from sensors and/or streaming music, for example.

FIG. 1 therefore illustrates mobile 110 in communication with a cellular system via link 115, a local-area system via link 125, a short-range device via link 103 and a satellite system via links 135a, 135b and 135c. Not all the devices and/or systems illustrated are present in all embodiments of the invention, and some embodiments may have further wireless links which are not illustrated in FIG. 1, for example a near-field communication, NFC, link.

Depending on spectrum allocation decisions and technical features of mobile 110, it is possible that at operation of at least one of the links interferes with usage of at least one other link. For example, using short-range link 103 on one of the possible frequencies or frequency-hop patterns may interfere with a sub-section of the frequency band usable for local area link 125 and/or cellular link 115. As another example, using link 125 in a certain, predefined way may cause some satellite communication over links 135a, 135b and 135c to become more difficult. A link may interfere with another link in more than one way. For example, first link may interfere with a second link directly where the first link transmits using a frequency, or an adjacent frequency to a frequency, that the second link attempts to use for at least one of reception and transmission. Alternatively, a transceiver chain of the first link may generate an intermediate frequency that occupies the same frequency as the second link is using, or a transceiver chain of the second link is using. In addition to frequencies used for transmission in the first link and intermediate frequencies of the first link, harmonics of such frequencies may cause spurious energy on frequencies that the second link is relying on. In general, interference from one link comprised in mobile 110 that interferes with another link comprised in mobile 110 may be called in-device multiradio interference.

Mobile 110 may be furnished with information, which frequencies are capable of interfering with which frequencies on a per-link basis. This information may be called information on potential interference. The information may comprise information concerning the extent of any interference. In the context of this document, “interference” is understood broadly as impeding, rendering more difficult or interfering. The information may comprise for a first link a list of frequencies, and for each frequency usable for the first link an indication of whether using the frequency on the first link can interfere with operation of any second link comprised in mobile 110. The information may identify which second link and which frequencies thereof, and to what extent, using the frequency on the first link is capable of interfering. The information on potential interference may comprise information concerning potential interference caused by all links comprised in mobile 110.

Using the information on potential interference, mobile 110 can predict which frequencies on link cellular 115, for example, may be interfered by using a certain set of frequencies on local area link 125, for example. Likewise using a certain channel or channels on cellular link 115 may interfere with reception of satellite positioning signals from satellites 140. Depending on requirements, mobile 110 may inform base station 120 which channels it would be preferable to use on cellular link 115. As an example, mobile 110 may inform base station 120 which channels on cellular link 115 are interfered by other links currently in use in mobile 110. Mobile 110 may inform base station 120 which channels on cellular link 115 would be capable of causing interference on other links. As another example, in an emergency call routed over cellular link 115, reception of positioning signals from satellites 140 may be important to locate mobile 110. Therefore mobile 110 may advise base station 120 to allocate channels that don't interfere with reception of satellite links 135a, 135b and 135c. Similarly, mobile 110 may inform nodes of other communication links, such as access point 130 and headset 101, which channels of those systems it would be preferable to use or not to use on those links.

Taking the foregoing into consideration, mobile 110 may be configured to transmit a message to base station 120 which comprises channel information. Base station 120 may be configured to receive the channel information and use it when allocating channels for use in cellular link 115. The message to the base station may be a measurement report, status report, information container or other kind of message. The message may be sent in several parts. The message may be sent on a control channel or a data channel and the message may be comprised in a connection request, for example a bearer establishment request or attachment request. To compile the channel information, mobile 110 may obtain information of in-device multiradio interference. The information on in-device multiradio interference may be based on the information on potential interference discussed above. The information on in-device multiradio interference may further be based on information on which links are active, and which frequencies the active links are using. The information on in-device multiradio interference may comprise information concerning which applications are using links causing interference, or information concerning which applications are using links that are interfered, or may become interfered. The information on in-device multiradio interference may be obtained by measuring interference and comparing the occurrence of interference to a transmit timing scheme or link quality of another link, wherein it is determined that a first link interferes with a second link when interference is detected on the second link when the first link transmits. The information on potential in-device interference may be preconfigured in the device, or the device may have learnt it by measuring in the past.

The channel information may comprise at least one indication of priority assigned by mobile 110 to a channel that is potentially usable on link 115, that is it is comprised in the overall frequency allocation to link 115 and may be allocated for use by base station 120. The priority may be assigned in dependence of the information on in-device multiradio interference. In an embodiment, mobile 110 is configured to assign a high priority to a channel, meaning mobile 110 recommends the use of the channel, when it is determined by mobile 110 that the channel doesn't have the potential to cause interference to any link currently in use in mobile 110. The assigned priority may also be high when mobile 110 determines that no currently used link is causing interference to the channel. Mobile 110 may be configured to assign a lower priority to a channel that is either interfered by another link presently in use, or capable of interfering another link currently in use. Mobile 110 may be configured to assign the highest priorities to channels that are not potentially capable of interfering with, or potentially interfered by, any channel or frequency of any other link comprised in mobile 110, taking into account the overall frequency allocations of the other links comprised in mobile 110. The channel information may comprise priority information in a number of ways. For example, the channel information may comprise priority information only concerning channels with a priority level that is not a default priority level. The channel information may comprise a listing of all channels in a priority order. The channel information may comprise indications of a priority class for each allocatable channel, and/or for each potentially interfered/interfering channel.

Mobile 110 may be configured to include in the channel information for at least one channel an indication that the channel is blocked. A blocked channel is a channel concerning which there is an active link in mobile 110 operating on such a frequency as to interfere with the blocked channel to a significant degree. An indication of blocked channel may be considered by base station 120 to be an indication to not allocate the blocked channel for use on cellular link 115, as long as other channels are available. Mobile 110 may be configured to apply a threshold interference level to determine whether to assign to a channel a low priority or to indicate the channel as blocked. The channel information may comprise priority information on channels that are not indicated to be blocked and indications that some channels are blocked. Alternatively the channel information may comprise only information concerning channels indicated as blocked.

In some embodiments, mobile 110 may consider the information concerning which applications are using links causing interference, or information concerning which applications are using links that are or could be interfered when assigning priorities to channels. For example, there may be two channels allocatable by base station 120 on cellular link 115, which are here termed channel A and channel B. Channel A is a potential interferer to the short-range link 103 connecting mobile 110 to wireless headset 101, and channel B is a potential interferer to local area link 125. In this situation mobile 110 may be configured to assign a higher priority to channel B, since interference to the headset might impact voice call quality which would be perceived by the user, whereas interference to local area link 125 may not be noticeable if the local area link 125 is used for background-type applications such as receiving email. In general, mobile 110 may be configured to assign a low priority to a channel capable of interfering a link used by an application that has a high application priority. Mobile 110 may be configured to assign a lower priority to a first channel that is interfered by another channel, or interferes with another channel, to a higher degree than does a second channel. The user of mobile 110 may configure application priorities concerning applications comprised in mobile 110, to thereby affect channel allocation and provide prioritized access to radio resources to applications he considers important or urgent.

Information on applications may also be used by mobile 110 to determine that a channel is blocked. For example, where channel A is capable of interfering with positioning satellite links 135a, 135b and 135c and channel B is capable of interfering with short-range link 103, channel B may be assigned a low priority and channel A may be indicated as blocked. The reason for this may be that when mobile 110 places an emergency call via cellular link 115, positioning capability may be a statutory requirement, or at least highly desirable in a medical emergency.

The channel information may comprise priority information defining priorities for channels that are indicated as blocked. Base station 120 may consider channels indicated as blocked as channels to be avoided when allocating channels for use in cellular link 115. If base station 120 is requested to allocate channels for a connection over cellular link 115 and not enough non-blocked channels are available, base station 120 may be configured to refuse the connection. Alternatively, where the connection may not be refused, base station 120 may consult the priority information defining priorities for channels indicated as blocked. A connection that may not be refused may be an emergency communication, a notification from authorities or an outgoing voice call, if mobile 110 is so configured. Where base station 120 relies on blocked channels to build a connection over cellular link 115, it may be configured to select the blocked channels with priority that indicates they are most preferable for use despite being blocked. Using a blocked channel may comprise using the blocked channel with sufficient power to overcome interference.

Responsive to mobile 110 receiving a notification from base station 120 that blocked channels are to be used for a connection on cellular link 115, mobile 110 may be configured to determine the reason the channels were indicated as blocked in channel information transmitted to base station 120. Responsive to determining the reason, mobile 110 may be configured to attenuate the reason, for example where a communication on a first link causes interference to the blocked channels, mobile 110 may reduce a transmit power of the first link. Alternatively mobile 110 may cause communication on the first link to move to another frequency, which no longer blocks the blocked channel or channels. For example where mobile 110 receives information that the connection to be established on cellular link 115 is an emergency call, it may disconnect an interfering communication on the first link.

Mobile 110 may be configured to assign a priority to at least one channel indicated in channel information as blocked responsive to determining that there remain fewer than a threshold number of non-blocked channels. The threshold number may correspond to a minimum number of channels, or more generally radio resources, needed to establish a voice call over link 115. The threshold number may be configurable by the user, base station 120 or a further network element, which is not illustrated in FIG. 1.

In some embodiments, a priority level assigned to a channel indicated in channel information as blocked comprises at least one of interruptible for emergency calls and not interruptible for emergency calls. For example, as described above, satellite communication links may be non-interruptible even in case of emergency calls. Therefore mobile 110 may be configured to indicate channels as blocked and not interruptible for emergency calls when the information on potential interference indicates that using these channels for a connection on cellular link 115 would interfere with reception of satellite links 135a, 135b and 135c.

In some embodiments, channel information sent from mobile 110 to base station 120 also comprises additional channel information. The additional information may indicate, for example, if a channel is interfered by another link or is capable of interfering another link, or whether the potential for interference is mutual, or whether the interference time characteristics is known. The additional information may comprise time characteristics of interference, for example a periodicity, end time or start time of an interfering signal.

In some embodiments, mobile 110 may report priority classes of the channels. A priority class may indicate some characteristics of the channels belonging to the class. For example a priority class may indicate that the channels are good, another may indicate that the channels are possible for use, and yet another that channels are blocked from use. Some priority class may indicate that the channel is possible for operation part time and the time characteristics are known, and some other priority class may indicate that the channel is possible for operation part time and the time characteristics are not known.

In some embodiments, mobile 110 may report characteristics of interference instead of reporting the useable channels with priority information, and/or blocked channels. The interference characteristics, such as interference center-frequency, interference source and interference level, for example, may be included in the report. In addition, to the interference characteristics, the mobile 110 may assign a priority to the interference. From the reported interference characteristic and the interference priority, base station 120 may determine the priority of useable channels, and the blocked channels, for communication with the mobile. The interference priority may be determined similarly to the channel priority above. Important applications operating on links being interfered may be indicated as high priority interferences. In such case the interference characteristics may indicate low or even no interference to the channels, but high interference priority. In these embodiments, the interference priority indicates the importance of the link causing or suffering the reported interference.

Whereas the foregoing is discussed in terms of base station 120 allocating channels for use on cellular link 115, the scope of the invention extends also to embodiments where base station 120 receives the channel information and forwards at least part of it to a further network node, not illustrated in FIG. 1, which is configured to allocate channels.

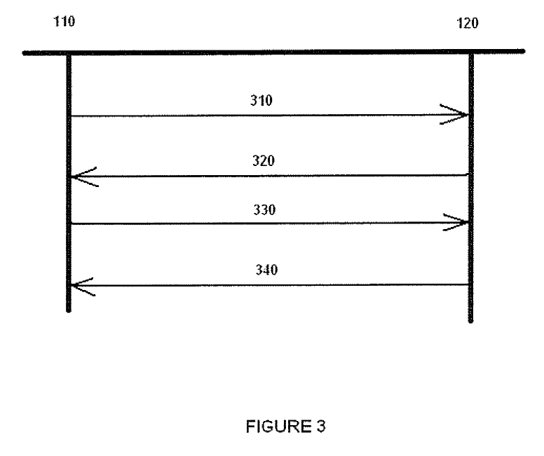

FIG. 3 is a signaling diagram relating to an example embodiment of the invention. On the vertical axes 110 denotes mobile 110, which may substantially correspond to mobile 110 of FIG. 1. Likewise 120 denotes base station 120 which may substantially correspond to base station 120 of FIG. 1. The horizontal arrows denote messages exchanges between mobile 110 and base station 120 via cellular link 115.

Message 310 may be a capability information message transmitted from mobile 110 to base station 120. The capability information message may comprise, for example, an indication that mobile 110 is a multiradio device with at least one active or activatable link in addition to cellular link 115. The capability information message may also inform base station 120, or another network node, which radios mobile 110 has in addition to a cellular radio. Message 310 is optional in the sense that there exist embodiments of the invention that don't comprise message 310.

Message 320 may be a radio resource configuration message. Base station 120 may be configured to transmit message 320, for example, responsive to a determination that the set of allocatable channels for cellular link 115 changes. Message 320 may comprise an explicit or implicit request for channel information from mobile 110. The explicit or implicit request for channel information may be a request for mobile 110 to transmit new channel information each time channel information changes. The request may take the form of an information element, IE, comprised in message 320. The IE may be a ReportICO and/or ReportICOClass IE. The request may relate to only one channel or a sub-set of all allocatable channels. Message 320 is optional in the sense that there exist embodiments of the invention that don't comprise message 320.

Message 330 may be a report message transmitted from mobile 110 to base station 120. The report message may comprise the channel information described above in connection with FIG. 1. Mobile 110 may be configured to transmit message 330 responsive to receiving message 320, responsive to a timer expiring, responsive to a change in the channel information, or responsive to attaching to a new base station 120, for example. In some embodiments message 330 may comprise channel information in indirect form, where a center frequency of interference is reported along with, optionally, information concerning a spectral shape of the interference, and the priority of the interference. Based on the indirect information, base station 120 may infer which channels, and to what extent, are interfered. Where channel information is in indirect form, separate priority information and/or information on blocked channels may be omitted from channel information.

Message 340 may be a connection configuration message transmitted from base station 120 to mobile 110. Message 340 may comprise information on at least one channel allocated by base station 120 or another node to a connection on cellular link 115. The allocating may be at least in part in dependence of the channel information received in message 330. Message 340 may comprise information relating to the connection, for example an indication that the connection is for conveying an emergency or official communication over cellular link 115.

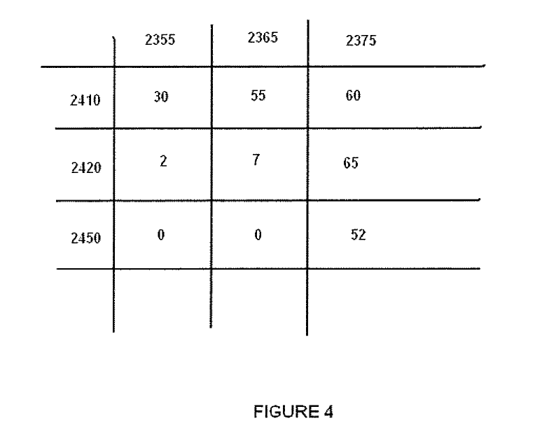

FIG. 4 illustrates information on potential interference. Devices such as, for example, mobile 110 of FIG. 1 may be furnished with information on potential interference either via pre-configuration at the factory or dynamically over the air, for example when knowledge of information on potential interference develops.

FIG. 4 illustrates information on potential interference concerning one pair of links comprised on mobile 110, for example a cellular link 115 and a short-range link 103 such as Bluetooth. Illustrated on the horizontal axis is a cellular frequency, for example a long term evolution channel center frequency and on the vertical axis is a short-range frequency. The frequency labels are in megahertz units. The data in the illustrated table discloses the extent to which the cellular link 115 interferes with the short-range link 103. For example, when the cellular link 115 is operating at a channel center frequency of 2365 megahertz, in the illustrated example sensitivity of the short-range link 103 is reduced by 55 decibels when the short-range link 103 operates at a channel center frequency of 2410 megahertz, by 7 decibels when the short-range link 103 operates at a channel center frequency of 2420 megahertz and the short-range link 103 channel centered on frequency 2450 megahertz is not interfered at all.

Information on potential interference comprised in mobile 110 may comprise similar information in the other direction, that is interference caused by the short-range link 103 to the cellular link 115, and for all link pairs comprised in mobile 110 and both directions thereof. It is also possible that links that are not interfered by others and do not even potentially interfere others are not associated with information on potential interference, since the information would comprise zeroes. In some embodiments, instead of decibel values channel pairs are assigned to categories such as no interference, mild interference and severe interference.

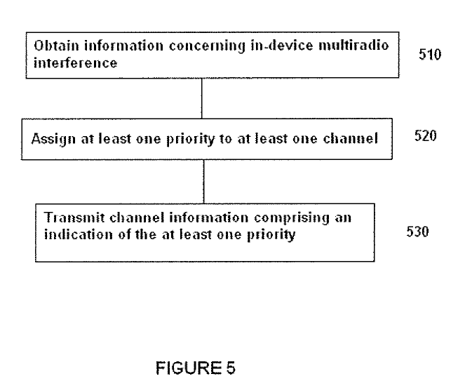

FIG. 5 is a flowchart of a method according to an example embodiment of the invention. In phase 510, information concerning in-device multiradio interference is obtained. This may be obtained from information on potential interference and information on links and frequencies presently in use, for example. The information on potential interference and the information on links and frequencies currently in use may be stored and obtained internally in mobile 110, for example.

In phase 520, at least one priority is assigned to at least one channel, for example on cellular link 115. In some embodiments, more than one channel is assigned a priority. The assigning may comprise that at least one channel is indicated as being blocked, and the assigning may comprise that at least one blocked channel is assigned a priority, for example a priority class.

In phase 530, channel information comprising the assigned at least one priority is transmitted, or caused to be transmitted, to base station 120, for example. Causing the channel information to be transmitted may comprise sending from a transmitter comprised in a processor or chip a signal into which the channel information is encoded, to a radio transmitter comprised in mobile 110.

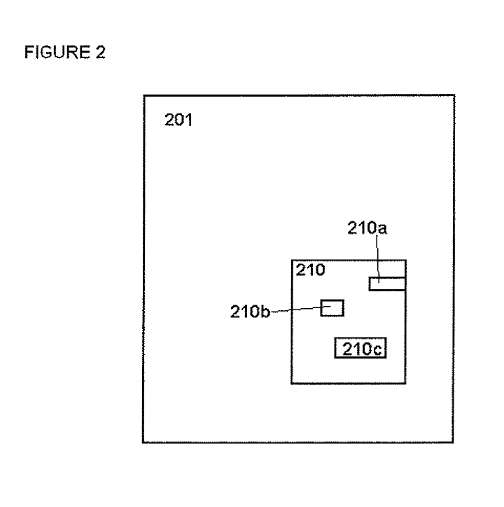

FIG. 2 illustrates an example apparatus 201 capable of supporting embodiments of the present invention. The apparatus may correspond to apparatus 110, or base station 120, for example. The apparatus is a physically tangible object, for example a mobile telephone, personal digital assistant, data dongle or a similar device. The apparatus may comprise a control apparatus 210, for example a digital signal processor, DSP, processor, field-programmable gate array, FPGA, application-specific integrated circuit, ASIC, chipset or controller. The apparatus may further comprise a transmitter and/or a receiver 210a configured to enable the apparatus 201 to connect to other apparatuses. A combination of transmitter and receiver may be called a transceiver. The apparatus may comprise memory 210b configured to store information, for example channel information. The memory may be solid-state memory, dynamic random access memory, DRAM, magnetic, holographic or other kind of memory. The apparatus may comprise logic circuitry 210c configured to access the memory 210b and control the transmitter and/or a receiver 210a. The logic circuitry 210c may be implemented as software, hardware or a combination of software and hardware. The logic circuitry may comprise a processing core. The logic circuitry 210c may execute program code stored in memory 210b to control the functioning of the apparatus 201 and cause it to perform functions related to embodiments of the invention. The logic circuitry 210c may be configured to initiate functions in the apparatus 201, for example the sending of data units via the transmitter and/or a receiver 210a. The logic circuitry 210c may be control circuitry. The transmitter and/or a receiver 210a, memory 210b and/or logic circuitry 210c may comprise hardware and/or software elements comprised in the control apparatus 210. Memory 210b may be comprised in the control apparatus 210, be external to it or be both external and internal to the control apparatus 210 such that the memory is split to an external part and an internal part. If the apparatus 201 does not comprise a control apparatus 210 the transmitter and/or a receiver 210a, memory 210b and logic circuitry 210c may be comprised in the apparatus as hardware elements such as integrated circuits or other electronic components. The same applies if the apparatus 201 does comprise a control apparatus 210 but some, or all, of the transmitter and/or a receiver 210a, memory 210b and logic circuitry 210c are not comprised in the control apparatus 210. In embodiments where apparatus 201 is a mobile user equipment, apparatus 201 may comprise at least one antenna.

Without in any way limiting the scope, interpretation, or application of the claims appearing below, a technical effect of one or more of the example embodiments disclosed herein is that usage of radio resources such as channels is made more efficient. Another technical effect of one or more of the example embodiments disclosed herein is that multiradio coexistence in mobile terminals is facilitated. Another technical effect of one or more of the example embodiments disclosed herein is that the success rate of emergency communication is increased.

Embodiments of the present invention may be implemented in software, hardware, application logic or a combination of software, hardware and application logic. The software, application logic and/or hardware may reside on control apparatus 210, logic circuitry 210c or memory 210b, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a transmitter configured to output information;
a processing core configured to obtain information concerning in-device multiradio interference;
the processing core being configured to assign at least one priority to at least one channel of a first radio access technology in dependence of the information concerning in-device multiradio interference; and
the processing core being configured to cause the transmitter to output channel information comprising an indication of the at least one priority for transmission to a base station of the first radio access technology.

2. An apparatus according to claim 1, wherein the channel information comprises an indication that at least one channel of the first radio access technology is blocked.

3. An apparatus according to claim 1, wherein the processing core is configured to assign the at least one priority to the at least one channel in dependence of applications causing in-device multiradio interference to the at least one channel, whereby applications considered important are given prioritized access to radio resources.

4. An apparatus according to claim 2, wherein the channel information comprises for the at least one blocked channel an indication of priority.

5. An apparatus according to claim 4, wherein the processing core is configured to assign the at least one priority to the at least one blocked channel responsive to determining that a number of not blocked channels is less than a predefined threshold number.

6. An apparatus according to claim 4, wherein the priority of the at least one blocked channel comprises at least one of interruptible for emergency calls and not interruptible for emergency calls.

7. An apparatus according to claim 1, wherein the channel information comprises additional information, the additional information comprising information concerning at least one of at least one direction of in-device multiradio interference for the at least one channel and time characteristics of interference.

8. An apparatus according to claim 1, wherein the apparatus comprises a mobile communication device, the apparatus further comprising an antenna coupled to a transceiver, the transceiver coupled to the transmitter and the antenna configured to provide signals to the transceiver.

9. A method, comprising:
obtaining information concerning in-device multiradio interference;
assigning at least one priority to at least one channel of a first radio access technology in dependence of the information concerning in-device multiradio interference; and
causing a transmitter to output channel information comprising an indication of the at least one priority for transmission to a base station of the first radio access technology.

10. A method according to claim 9, wherein the channel information comprises an indication that at least one channel of the first radio access technology is blocked.

11. A method according to claim 9, wherein the assigning comprises assigning the at least one priority to the at least one channel in dependence of applications causing in-device multiradio interference to the at least one channel, whereby applications considered important are given prioritized access to radio resources.

12. A method according to claim 10, wherein the channel information comprises for the at least one blocked channel an indication of priority.

13. A method according to claim 12, wherein the assigning comprises assigning the at least one priority to the at least one blocked channel responsive to determining that a number of not blocked channels is less than a predefined threshold number.

14. A method according to claim 12, wherein the priority of the at least one blocked channel comprises at least one of interruptible for emergency calls and not interruptible for emergency calls.

15. A method according to claim 9, wherein the channel information comprises additional information, the additional information comprising information concerning at least one of at least one direction of in-device multiradio interference for the at least one channel and time characteristics of interference.

16. An apparatus, comprising:
at least one processor; and
at least one memory including computer program code
the at least one memory and the computer program code configured to, with the at least one processor, cause the apparatus to perform at least the following:
receive channel information comprising an indication of at least one priority assigned to at least one channel of a first radio access technology;
choose a channel of the first radio access technology for communication with a mobile station in dependence of the channel information and information relating to a communication to be established over the channel, wherein the channel information comprises information on at least one blocked channel, and an indication of priority relating to the at least one blocked channel.

17. A computer program product comprising a computer-readable storage device configured to cause, when run on at least one processor, a method according to claim 9 to be performed.

18. (canceled)

19. A method, comprising:
obtaining information concerning in-device multiradio interference;
assigning at least one priority to at least one interference for a first radio access technology in dependence of the information concerning in-device multiradio interference; and
causing a transmitter to output interference information comprising an indication of the at least one priority for transmission to a base station of the first radio access technology.

20. A computer program product comprising a computer-readable storage device configured to cause, when run on at least one processor, a method according to claim 19 to be performed.
